(19) United States
(12) Patent Application Publication
(10) Pub. No.: US 2024/0280411 A1
(43) Pub. Date: Aug. 22, 2024

(54) METHOD AND DEVICE FOR UNOBTRUSIVE EXTRACTION OF SMOKING TOPOGRAPHY

(71) Applicant: Northwestern University, Evanston, IL (US)

(72) Inventors: Rawan Mansour S Alharbi, Chicago, IL (US); Nabil Iyad Alshurafa, Chicago, IL (US); Soroush Shahi, Evanston, IL (US)

(21) Appl. No.: 18/581,898

(22) Filed: Feb. 20, 2024

Related U.S. Application Data
(60) Provisional application No. 63/486,020, filed on Feb. 20, 2023.

(51) Int. Cl. G01J 5/48; G01J 5/00; G08B 21/18

(52) U.S. Cl. CPC G01J 5/48; G01J 2005/0077; G08B 21/18

(57) ABSTRACT

A smoke monitoring device includes an enclosure. The enclosure includes a mount that attaches the enclosure to a user. The smoke monitoring device also includes a thermal sensor positioned within the enclosure. The smoke monitoring device further includes a processor operatively coupled to the thermal sensor and configured to receive data from the thermal sensor. The processor is also configured to determine smoking topography information based on the received data.

### CROSS-REFERENCE TO RELATED APPLICATION

The present application claims the priority benefit of U.S. Provisional Patent App. No. 63/486,020 filed on Feb. 20, 2023, the entire disclosure of which is incorporated by reference herein.

### BACKGROUND

Smoking is the leading cause of preventable death worldwide. Globally, over 8 million deaths are attributed to smoking each year. Cigarette smoke includes thousands of chemicals that are harmful and cause tobacco-related diseases. In the United States, smoking-related illness is responsible for roughly one in five deaths annually. The staggering toll of smoking on human life has spurred large-scale public health efforts to raise awareness of the health risks of smoking and reduce smoking prevalence, including through a US Department of Health and Human Services “Healthy People 2030” initiative. To date, the causality between human exposure to specific compounds and the harmful effects resulting from such exposure is unknown.

### SUMMARY

An illustrative smoke monitoring device includes an enclosure. The enclosure includes a mount that attaches the enclosure to a user. The smoke monitoring device also includes a thermal sensor positioned within the enclosure. The smoke monitoring device further includes a processor operatively coupled to the thermal sensor and configured to receive data from the thermal sensor. The processor is also configured to determine smoking topography information based on the received data.

In an illustrative embodiment, the received data comprises temperature readings obtained by the thermal sensor, and the processor determines whether the temperature readings correspond to a smoking event. In another embodiment, the processor determines whether the temperature readings correspond to the smoking event based on a position of the detected temperature readings relative to a hand or a mouth of the user. In one embodiment, the received data only includes temperature readings that exceed a temperature threshold that is based on a smoking event.

In another illustrative embodiment, the smoking topography information includes a duration of a puff of a cigarette by the user. The smoking topography information can also include a volume of a puff of a cigarette by the user. The smoking topography information can further include a duration of time between an end of a puff and a start of a subsequent puff. In another embodiment, the device includes a transceiver operatively coupled to the processor, where the transceiver sends an alert to the user based on the smoking topography information. In another embodiment, the device includes a transceiver operatively coupled to the processor, where the transceiver sends an alert to the user if the thermal sensor is out of position. In one embodiment, the mount includes a pair of magnets that attach the enclosure to clothing of the user. In another embodiment, the mount comprises a pin or an adhesive. In one embodiment, the received data comprises an indication of when a cigarette is lit by the user.

An illustrative method of monitoring smoking includes mounting an enclosure to a user, where the enclosure includes a thermal sensor. The method also includes collecting, by the thermal sensor, temperature readings associated with the user. The method further includes determining, by a processor operatively coupled to the thermal sensor, smoking topography information based on the temperature readings. The method can also include determining, by the processor, whether the temperature readings correspond to a smoking event based on a position of the temperature readings relative to a hand or a mouth of the user.

In an illustrative embodiment, the collected temperature readings exceed a temperature threshold that is based on a smoking event. In another embodiment, the smoking topography information includes a duration of a puff of a cigarette by the user and a volume of a puff of a cigarette by the user. In another embodiment, the smoking topography information includes a duration of time between an end of a puff and a start of a subsequent puff. In one embodiment, the method includes sending, by a transceiver operatively coupled to the processor, an alert to the user based on the smoking topography information. In another embodiment, the method includes sending, by a transceiver operatively coupled to the processor, an alert to the user if the thermal sensor is out of position.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A depicts use of a chest-worn thermal-sensing wearable smoke monitoring device in accordance with an illustrative embodiment.

FIG. 1B depicts how the device captures spatial, temporal, and thermal information around the wearer and cigarette in accordance with an illustrative embodiment.

FIG. 1C depicts results of all day monitoring with the device to unobtrusively and passively detect smoking events and estimates of smoking topography in accordance with an illustrative embodiment.

FIG. 2 depicts a table of variables that can be used to quantify smoking topography in accordance with an illustrative embodiment.

FIG. 3 depicts a table that provides metrics and comparisons between thermal cameras available off-the-shelf in accordance with an illustrative embodiment.

FIG. 4A depicts thermal capture fine-grained information about cigarette ignition in accordance with an illustrative embodiment.

FIG. 4B depicts thermal capture fine-grained information about cigarette tip during a smoking session in accordance with an illustrative embodiment.

FIG. 4C depicts thermal capture fine-grained thermal, spatial, and temporal information that demonstrates a non-puff (when the cigarette is in the FoV but not in the mouth) in accordance with an illustrative embodiment.

FIG. 4D depicts thermal capture fine-grained information about a puff (when the cigarette is near the mouth) in accordance with an illustrative embodiment.

FIG. 4E depicts thermal capture fine-grained information about when there is no cigarette present in accordance with an illustrative embodiment.

FIG. 5 shows the correlation (Pearson's r=0.77) between the normalized ground truth puff volume obtained from a traditional device and the one calculated from the thermal data by integrating over the maximum temperature rate of change during the puff in accordance with an illustrative embodiment.

FIG. 6 shows examples of how a thermal sensor captures rich information that can be used to distinguish between different hand-to-mouth gestures with and without objects in hand, such as smoking, eating, drinking, and touching the head or mouth in accordance with an illustrative embodiment.

FIG. 7 depicts an enclosure and attachment mechanisms for the proposed device to maximize comfort while enabling reliable data collection in accordance with an illustrative embodiment.

FIG. 8 is a table that presents the average current draw of various states that the device supports, including a storage state, a transmission state, and a sensing-only state in accordance with an illustrative embodiment.

FIG. 9A depicts extraction of possible smoking sessions based on thermal information in accordance with an illustrative embodiment.

FIG. 9B depicts a puff-detection model that was run on each frame in the extracted session in accordance with an illustrative embodiment.

FIG. 9C depicts the results of postprocessing to extract puffing events and the smoking topography of the session in accordance with an illustrative embodiment.

FIG. 10 depicts a heuristic-based algorithm to analyze collected data and generate smoking topography information in accordance with an illustrative embodiment.

FIG. 11 depicts the experimental setup used to confirm efficacy of the proposed device in accordance with an illustrative embodiment.

FIG. 12 includes a table with details about the collected smoking topography using the traditional device in accordance with an illustrative embodiment.

FIG. 13 includes a table that provides summary statistics of the data collected in the wild in accordance with an illustrative embodiment.

FIG. 14 includes a table that shows the number of smoking and puff event statistics for each participant of the in-wild study in accordance with an illustrative embodiment.

FIG. 15A shows agreement between ground truth and the proposed device in measuring puff duration in accordance with an illustrative embodiment.

FIG. 15B shows agreement between ground truth and the proposed device in measuring duration of time between the end of a puff and the start of a subsequent puff (IPI) in accordance with an illustrative embodiment.

FIG. 15C shows agreement between ground truth and the proposed device in measuring puff volume in accordance with an illustrative embodiment.

FIG. 16 includes a table that highlights the results of puff event and smoking session detection from the in-wild experiment using the proposed device in accordance with an illustrative embodiment.

FIG. 17A shows agreement between ground truth and the proposed device for in-wild puff duration in accordance with an illustrative embodiment.

FIG. 17B shows agreement between ground truth and the proposed device for in-wild IPI in accordance with an illustrative embodiment.

FIG. 18 is a table that shows the percentage of discarded frames from each participant in accordance with an illustrative embodiment.

FIG. 19 depicts participant survey results regarding sharing data collected by the proposed device in accordance with an illustrative embodiment.

FIG. 20 depicts a computing device for performing smoker monitoring and analysis in accordance with an illustrative embodiment.

### DETAILED DESCRIPTION

Although smoking is known to be harmful, the majority of what is known regarding the relationship between human exposure to tobacco and the harmful effects is predominantly based on self-report; controlled laboratory environments, environmental sensors, and blood, saliva, or urine tests. These methods are unreliable and/or expensive, and do not capture active smoking behaviors. Using traditional devices, exposure to tobacco through smoking still lacks an ideal method of measurement in natural settings.

Recent nicotine and tobacco research studies demonstrate the importance of measuring smoking exposure through smoking topography or fine-grained measures of smoking patterns. Benefits of studying smoking topography include (1) measuring and assessing harmful carbon monoxide exposure among smokers, (2) understanding the relationship between chemical exposure and tobacco related diseases, and (3) providing measures to predict abstinence post treatment. Smoking topography is measured during a smoking bout, which provides a summary of fine-grained measures of exposure, including timing of a puff, number of puffs, puff duration, puff volume, inter-puff interval (IPI), and smoking duration. Collectively, these topography measures provide a valid and reliable index of conventional smoking exposure.

Gold-standard methods in measuring smoking topography require smokers to attach the cigarette to one end of a device and smoke through a mouthpiece on the other end (e.g., CReSSPocket). The reduced realism of these smoking events alters the way participants smoke, impeding the ability of these devices to capture natural, habituated smoking behavior. To address this, researchers have investigated non-obtrusive ways to measure smoking behavior, including the use of inertial measurement unit (IMU) sensors in smartwatches. However, such approaches are often confounded by non-smoking hand-to-mouth gestures and consequently generate many false positives, suggesting motion-based sensing is inadequate for detecting smoking events and topography accurately when used alone. Wearable cameras, on the other hand, can capture temporal and spatial color information with which smoking can be distinguished from its confounding gestures. However, using video data introduces privacy and stigma concerns, limiting the applicability of camera-based approaches in natural settings.

Described herein is a smoke monitoring device (referred to as SmokeMon), which is an all-day wearable device that uses low-resolution thermal imaging to capture temporal, spatial, and thermal features of wearer smoking activity, including puffing behavior. A key observation used in designing SmokeMon is that smoking episodes have visibly distinctive thermal signatures (i.e., the temperature of the tip of a lit cigarette), as well as spatially and temporally distinctive features of hand-to-mouth smoking gestures. The proposed device advances current smoking behavior research by using a low-power, low-resolution thermal sensor to not only classify smoking sessions but also extract further information about the smoking activity (i.e., smoking topography) using machine learning in both controlled and natural settings.

The proposed smoke monitoring device is an all-day wearable device with a data-processing pipeline that enables detection of smoking activity and topography automatically and unobtrusively. The device operates without reliance on user input and without physically interfering with the cigarette or smoking gesture. The device is able to detect smoking events and extract smoking topography in both controlled and natural settings. Studies were conducted using the proposed device and a dataset showing smoking topography estimation using thermal imaging was created. Two annotated datasets (in the laboratory and in the wild) were also generated, enabling others to expand on the detection of smoking and the estimation of smoking topography using thermal image sensing. The experiments and their results are discussed in more detail below.

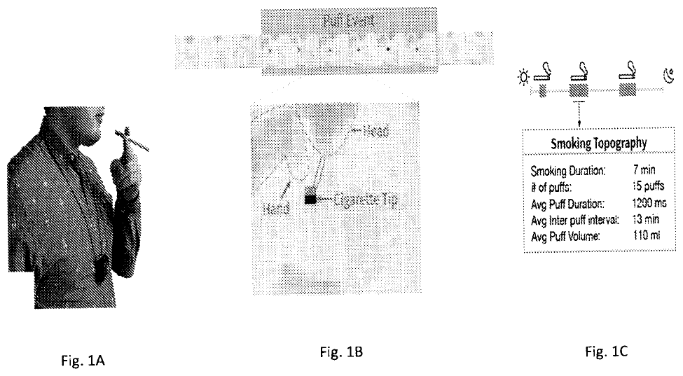

FIG. 1. depicts a smoke monitoring device. Specifically, FIG. 1A depicts use of a chest-worn thermal-sensing wearable smoke monitoring device in accordance with an illustrative embodiment. As shown, the device includes a lens pointed toward the wearer's mouth. FIG. 1B depicts how the device captures spatial, temporal, and thermal information around the wearer and cigarette in accordance with an illustrative embodiment. FIG. 1C depicts results of all day monitoring with the device to unobtrusively and passively detect smoking events and estimates of smoking topography in accordance with an illustrative embodiment.

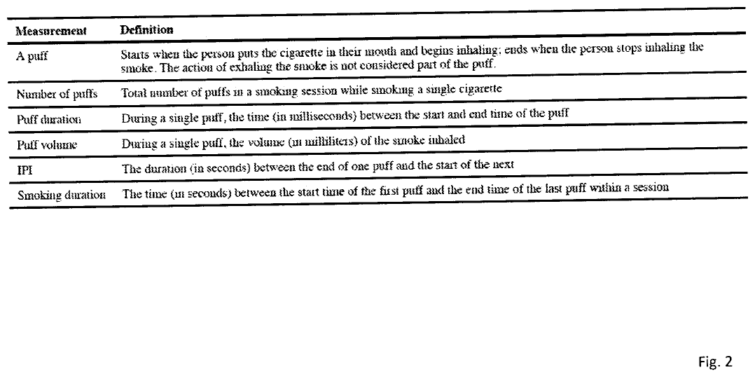

Smoking topography provides comprehensive quantification of the manner in which someone smokes through several variables. FIG. 2 depicts a table of variables that can be used to quantify smoking topography in accordance with an illustrative embodiment. The ability to quantify smoking behavior at such a level of detail will allow researchers to further understand factors that influence or maintain nicotine use. For example, smoking topography metrics have been shown to predict abstinence following treatment with nicotine replacement therapy, where IPI (duration of time between the end of a puff and the start of a subsequent puff) significantly predicted abstinence at the end of the trial. As a result of this finding, researchers are now paying closer attention to the effect of smoking cessation pharmacotherapy on smoking topography. Smoking topography has also helped explain why cigarettes labeled as “light,” “low,” or “mild” (i.e., low-yield cigarettes) have failed to minimize the harms of smoking. It has been shown that when people smoke low-yield cigarettes, they often take puffs with greater volume and duration than puffs taken while smoking high-yield cigarettes. This suggests that smokers often compensate for the reduced nicotine content of low-yield cigarettes by changing their puffing behavior.

Devices measuring smoking topography have improved significantly throughout their relatively short history. They began as in-lab devices with which users smoke a cigarette through a mouthpiece connected to a pressure transducer to measure airflow, from which smoking topography measures are then calculated. Despite their utility, these devices are bulky and obtrusive, requiring the smoker to inhale through a mouthpiece, altering the experience of smoking. Moreover, sharing a smoke-through device between participants requires thoroughly opening and cleaning the device between uses and constitutes a safety risk. These challenges have inspired many researchers to propose alternative approaches to smoking topography.

Tracking smoking events and topography in natural settings remains challenging. It has been found that hand-to-mouth gestures are a behavioral manifestation of the puffing event, prompting researchers to use motion-based sensors in wrist-worn devices to track hand-to-mouth gestures as a proxy for smoking behavior. Below we summarize additional behavioral manifestations of smoking events and expand upon their list to include the thermal manifestation of smoking.

Motion-based sensors such as IMUs can be used to track hand-to-mouth gestures as a proxy to smoking behavior. For example, inertial sensors can be used (e.g., accelerometer, gyroscope, magnetometer) both individually and in combination to detect these gestures. The smoking gesture can be detected using quaternion information from inertial sensors, using a smartwatch's accelerometer and gyroscope to detect smoking activity, etc. Although hand-to-mouth gestures are strong features of smoking behavior and can be used to extract puffing behavior, approaches that rely solely on hand-to-mouth gestures are often confounded by other common daily behaviors that require hand-to-mouth gestures (e.g., eating, drinking, touching the face).

Researchers have shown a difference between the pattern of inhalation/exhalation when smoking and the pattern of inhalation/exhalation when breathing regularly. Specifically, the respiratory pattern of smoking or puffs can be broken down into four phases: (1) a short period of breath-holding when the cigarette is in the mouth, (2) a sharp increase of airflow when smoke is inhaled, (3) a brief period to hold the smoke in the lungs, and finally (4) smoke exhalation through the nose or mouth. To measure this pattern, wearable respiratory inductance plethysmography (RIP) sensors can be used. RIP sensors include inductive threads usually embedded in belts or sewn into clothing. During the inhale and exhale process, the lungs contract and expand causing a change in the inductance of the belt. Although such an approach has shown promise in controlled laboratory experiments, in free-living contexts it requires the use of other sensors that capture hand-to-mouth gestures to increase confidence in the detection and eliminate confounding breaths. RIP signals are also known to be similar across multiple activities: standing, walking, resting idly in a chair, eating, and smoking cigarettes.

One way to track the frequency of smoking is by tracking the number of times a cigarette is ignited. For example, smart lighters can be used to timestamp the cigarette ignition event as a proxy to the start time of a smoking event. Although such an approach does not provide further smoking topography, it can be used with other methods to reduce false-positive events. For example, a smart lighter can be used in combination with a wrist-based sensor to detect smoking more accurately than could be done with either device alone.

Multiple low resolutions of 8×8 thermal sensors can also be used to detect human activity in a controlled environment. Using such sensors, classification of smoking sessions achieved a very high F-score (83.66%), which shows the promise of using thermal sensors for smoking session classification. As discussed in more detail below, the proposed device uses the thermal signature of lit cigarettes to classify smoking sessions and further detect and classify puffs within the smoking session to extract smoking topography. The device can also be used to collect thermal data from both controlled and natural living environments to provide insights on the feasibility of using thermal as a smoking topography device in the wild.

Sensing modalities or devices that can capture multiple manifestations or proxies of smoking behaviors have reported higher scores in detecting both smoking events and smoking topography. While multi-sensing approaches improved the scores of smoking detection, they impose an extra burden on users as they require charging and wearing multiple devices. Egocentric red-green-blue (RGB) cameras have shown significant improvement and potential in measuring many behavioral manifestations of smoking. However, they create privacy concerns, discomfort, or stigma for the wearer and the people around them. The proposed smoke monitoring device uses a low-resolution thermal camera that can sense many smoking behavior proxies such as the thermal signature of a lit cigarette, hand-to-mouth gestures, respiratory patterns (e.g., inhalation of smoke causing the temperature tip of the cigarette to increase), and cigarette lighting events, all without capturing unnecessary information in the environment that can trigger privacy concerns (as is the case with egocentric RGB cameras).

Thermal cameras capture infrared radiation emitted by objects in the environment. Thermal images include pixels representing the thermal radiation value of the object in the field of view, which can be used to calculate the temperature of the object. Humans, as well as many objects (including a lit cigarette), naturally emit thermal radiation that can be captured with a thermal sensor unobtrusively (i.e., without the need for contact). Over the years, researchers have used thermal sensing as a nonwearable sensing modality for in-room activity monitoring and other applications. However, traditional sensors do not classify or detect puffing events to extract smoking topography. The proposed device extends the work of existing devices by exploring the feasibility of a low-resolution thermal sensor to extract smoking topography. Moreover, does not use the same thermal sensors used in traditional devices because they fail to work in sub-zero Celsius climates, ruling out the potential of using the sensor in many seasons and some parts of the world.

Described below are the device design goals along with explorations performed to determine the best design choices, followed by the final device designed to measure smoking topography. Energy consumption and battery life for the device are also discussed. One goal for the device is to provide rich information that can capture multiple proxies of smoking behaviors to be more reliable in extracting smoking topography among known confounding activities. It is also desirable that data obtained from the device is easily verifiable and interpretable by a human. One of the main challenges in the area of human activity detection is the lack of fine-grained labeled datasets because it is challenging to obtain ground truth in free-living settings. The proposed device addresses this challenge by capturing data that are intelligible to humans and machines.

Wearable devices can introduce stigma and privacy concerns. As a result, the proposed device was also designed to minimally interfere with everyday activity, especially smoking. The design, sensor position, and data collected from the device should not introduce additional burden on the wearer, affecting them neither physically nor psychologically. The device was also designed to have low-power sensing to support all day wear. Smoking can happen at any time of the day. Therefore, the device was designed to last for at least 16 hours on a single charge. This number is calculated based on waking hours, assuming that a typical person needs 8 hours of sleep daily. It is also important that the device incorporates energy-efficient approaches and components to reduce the weight and size of the battery, while still providing all-day sensing. In alternative embodiments, a single charge of the device can last for more than 16 hours (e.g., 18 hours, 24 hours, etc.).

Smoking topography research has shown great promise in understanding smoking and nicotine intake habits and assessing the impact of smoking cessation interventions. In one embodiment, the proposed device provides an open platform to the research community to continue advancing the unobtrusive capture of longitudinal information about smoking behavior.

To attain the aforementioned design goals, the inventors explored multiple approaches. Based on testing and research, the thermal-based sensing approach provided the greatest promise in attaining the above-stated goals. The advantages of using a thermal-based approach in detecting smoking behavior are described below.

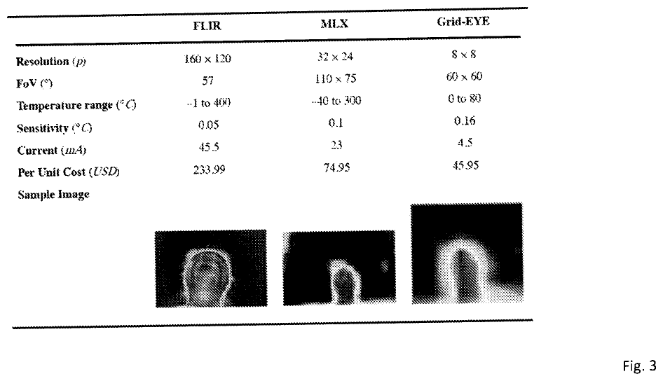

Low-resolution thermal cameras are light weight and energy efficient, making it possible to wear them continuously without burdening the participant. Because the thermal camera is worn on-body, the person will be in close proximity to the camera, making it sufficient to use a low-resolution thermal camera. However, it is important to ensure that the field of view (FoV) of the thermal camera is capable of capturing the wearer's hand and head movements. FIG. 3 depicts a table that provides metrics and comparisons between thermal cameras available off-the-shelf in accordance with an illustrative embodiment. The focus was on three different cameras that have different characteristics: (1) FLIR is a high-resolution thermal camera, (2) MLX is a low-resolution thermal camera, and (3) Grid-EYE is an ultra-low-resolution thermal camera. As evident from the sample images presented under the table in FIG. 3, each device is capable of capturing a silhouette of the human head when the camera is pointed upward from the chest, regardless of the device's resolution.

However, it is noted that the FLIR has an extremely high current draw compared with the other devices, which makes it unsuitable for longitudinal data collection. The FLIR was therefore removed from consideration. Initially, the Grid-EYE sensor appeared promising as it has a low current draw. To ensure that Grid-EYE addressed device needs, the inventors conducted a small experiment with the Grid-EYE device in which participants were asked to smoke while wearing the device. The Grid-EYE failed to work in contexts with an ambient temperature below 0° C. and therefore restricted the use of the Grid-EYE sensor to a few months and limited regions of the world. Using the Grid-EYE, it was also noticed that when the participants smoked sideways, the cigarette would go out of the FoV. Therefore, the inventors opted for the MLX sensor due to its larger FoV, allowing for a more robust capture of cigarette motion under many ambient temperature settings. Additionally, the larger FoV made the sensor less sensitive to wearing position. In alternative embodiments, a different type of infrared sensor/camera may be used.

One major advantage of thermal cameras is that they can capture thermal images even when they are covered with opaque materials. The ability to conceal the thermal camera increases the participant's comfort in wearing them. Researchers have shown that people grow uncomfortable when they see a camera lens, which in turn makes the wearer feel stigmatized, resulting in social avoidance, even if the camera does not record the bystander. Therefore, to increase comfort in wearing the proposed device, the inventors investigated different materials to cover the MLX lens. For example, a thermal-passing acrylic sheet and a thermal-passing black thin plastic sheet (similar to a garbage bag) were used to cover the lens. The thin plastic sheet was ultimately selected because it was easier to wrap around the opening of the camera. In alternative embodiments, a different type of lens covering may be used.

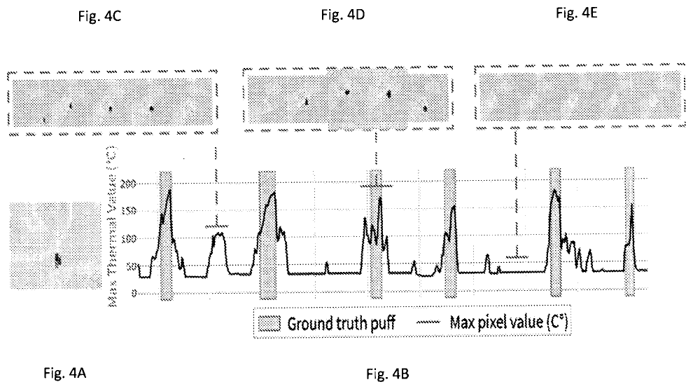

It is well understood that the more data one can capture from diverse smoking instances, the better the device's ability to predict and correctly model smoking behavior. Several observations confirmed that the thermal sensor provides rich smoking-related information. The proposed device takes advantage of spatiotemporal thermal data to capture the moment when someone lights up the cigarette. Also, the temperature of the cigarette during a smoking session provides valuable information about the puff. FIG. 4 shows a time series signal of the maximum pixel temperature during a smoking session. FIG. 4 also highlights the ground truth of a puff. More specifically, FIG. 4A depicts thermal capture fine-grained information about cigarette ignition in accordance with an illustrative embodiment. FIG. 4B depicts thermal capture fine-grained information about cigarette tip during a smoking session in accordance with an illustrative embodiment. FIG. 4C depicts thermal capture fine-grained thermal, spatial, and temporal information that demonstrates a non-puff (when the cigarette is in the FoV but not in the mouth) in accordance with an illustrative embodiment. FIG. 4D depicts thermal capture fine-grained information about a puff (when the cigarette is near the mouth) in accordance with an illustrative embodiment. FIG. 4E depicts thermal capture fine-grained information about when there is no cigarette present in accordance with an illustrative embodiment.

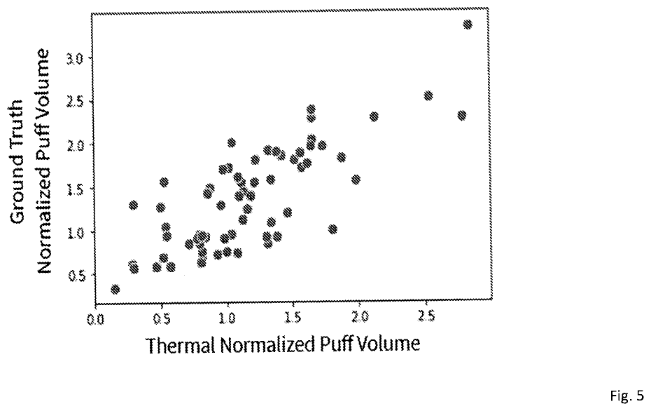

It is noted that thermal information alone may not be able to predict puffs accurately. This can be seen in FIG. 4C, where the cigarette is in the FoV but not in the mouth. A peak in the maximum pixel temperature can be seen when the cigarette is in the FoV. However, the spatiotemporal thermal information clearly shows that the cigarette is not near the mouth. Moreover, during the puff, one can see an increase in the cigarette temperature caused by the combustion process when the participant inhales air through the cigarette. This information can be used to approximate puff volume. FIG. 5 shows the correlation (Pearson's r=0.77) between the normalized ground truth puff volume obtained from a traditional device and the one calculated from the thermal data by integrating over the maximum temperature rate of change during the puff in accordance with an illustrative embodiment.

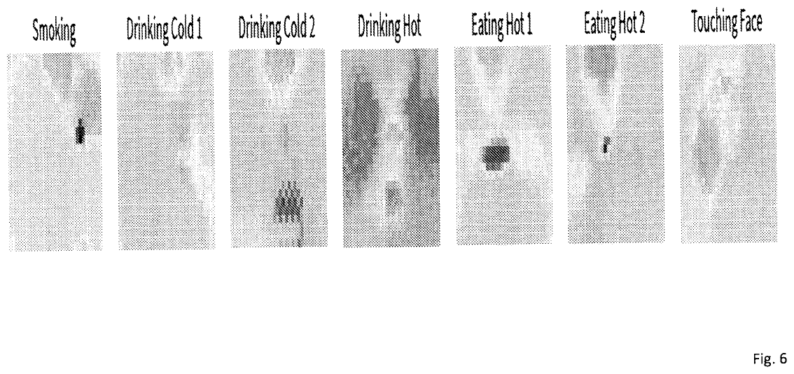

Hand-to-mouth gestures are often confounding, and research has shown how motion-based sensors like IMU often confound similar hand-to-mouth gestures like eating, drinking, and smoking. Thermal images provide useful information to the human and the machine, which helps in distinguishing between similar and often confounding hand-to-mouth gestures. FIG. 6 shows examples of how a thermal sensor captures rich information that can be used to distinguish between different hand-to-mouth gestures with and without objects in hand, such as smoking, eating, drinking, and touching the head or mouth in accordance with an illustrative embodiment. In one embodiment, the device generates a color map that maximizes the viewability of the image to a human reviewer. From the images, one can observe that the smoking gesture has a clear signature that is easily observable by a human reviewer and/or by a computing device that learns to capture this signature.

Described below is hardware used to implement the device. In alternative embodiments, different types of hardware components may be used. For the development of a device prototype, a development board equipped with a Cortex-M4-based Apollo 3 microcontroller and a BLE 5.0 radio was used. In addition, the board also contains an MCP73831 single-cell LiPo charger, a real-time Clock (RTC), and a micro-SD card socket, which are important components for in-wild deployment. The BLE transceiver and the micro-SD card slot are used for communication and data storage. In one embodiment, the device obtains the thermal images from a breakout board that contains an MLX90604 thermal sensor array and connects to the main board via an 12C-based connector. The size of each captured thermal image is 32×24 pixels in one embodiment, where each pixel represents a temperature reading ranging between −40° C. to 300° C. In alternative embodiment, a different size of the captured thermal images may be used.

It is also important to encapsulate the device in a wearable case that maximizes comfort and allows reliable data collection. The thermal camera in the device should be positioned in a way that allows capturing of the head and as much of the hand trajectory as possible. This allows confirmation of the cigarette going toward the mouth. Therefore, multiple mounts with different angles (centering the camera toward the chin, at 450 to 600 from the chest) were tested to hold the thermal sensor based on the wearer's chest size. For example, a person with a flat chest can have a mount with a 550 or more angle, whereas a person with a protruding chest will require a smaller angle. The position of the device on the chest was controlled using a necklace chain of fixed length. An optimal angle and chain length for the participants was determined during a laboratory visit. The angle and length were confirmed by visualizing the data obtained from the device in use. To prevent the device from flipping or moving out of place, a magnet attachment mechanism was provided for participants (i.e., one or more magnets were placed behind their clothing to connect with the magnet(s) with opposing poles embedded behind the device case).

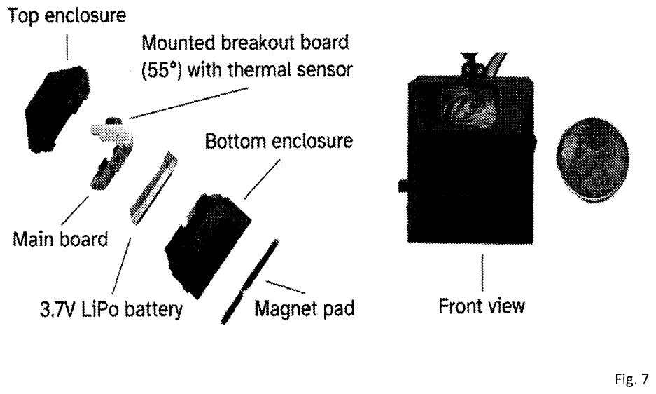

FIG. 7 depicts an enclosure and attachment mechanisms for the proposed device to maximize comfort while enabling reliable data collection in accordance with an illustrative embodiment. As shown, the device includes a top enclosure that mounts to a bottom enclosure that surround and protect the electronics of the device. The device also includes a main printed circuit board and a breakout board mounted to the main circuit board and including a thermal sensor. The main circuit board can include the processor, memory, transceiver, etc. The breakout board is mounted at 55 degrees relative to the main circuit board, but a different angle can be used for different users, depending on their body size/type. The device also includes a battery to power the device. Additionally, one or more magnets are mounted to the back of the bottom enclosure to help maintain a desired orientation of the device when worn by a user. As shown in the front view of the device, the lens of the thermal sensor is covered by an opaque plastic sheet.

In an illustrative embodiment, firmware of the device samples a timestamped thermal frame at 4 Hz (equivalent to 4 frames per second (fps)). In alternative embodiments, a different frame rate may be used, such as 2 fps, 3 fps, 5 fps, 8 fps, etc. Depending on the objective for using the device, the firmware can be set to save all timestamp data to an external SD card (e.g., a storage state) or can be set to stream data to another device using wired or wireless transmissions such as WI-FI, Bluetooth, cellular, etc. (transmission state). The storage state is useful when continuous and reliable data is favored over real-time streaming or processing of the data. For example, in an experimental test case, it is beneficial to save all collected data on an SD card or other memory to increase the reliability and validity of the experiment. Similarly, the device can use stored data to perform analysis offline at the end of the data collection process. On the other hand, a smoking cessation application might utilize the transmission state to send notifications to the user as a form of intervention or to offload data for further real-time processing on smartphones or other devices. The proposed device facilitates both cases by enabling the researchers or users of the device to choose the firmware state based on their goals. In addition to these two states, the device also supports a sensing-only state in which the device collects and processes thermal data.

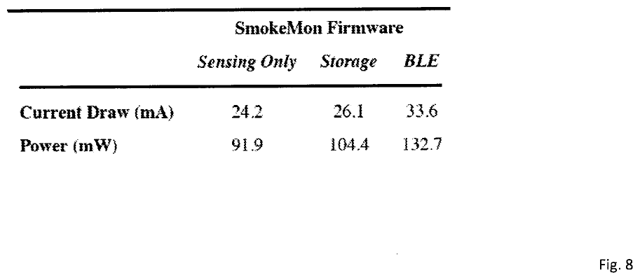

An INA219 current sensor was used to measure the power consumption of the device in each firmware configuration: sensing only, storage, and transmission states. FIG. 8 is a table that presents the average current draw of various states that the device supports, including a storage state, a transmission state, and a sensing-only state in accordance with an illustrative embodiment. To measure the current, the inventors connected the current sensor between the power source (e.g., a 500 mAh LiPo battery) and device ground (GND) and Voltage in (VIN) contacts on the board. The inventors then connected an Arduino board to the same current sensor via 12C to read the power profile of the device at a sampling frequency of 50 Hz. For each state, the power profile data was collected for 1 hour and the median current consumption was calculated for each state, as reported in FIG. 8. These numbers were used to estimate the battery life of the device.

For data collection, the device's storage state firmware was used. Based on the estimated current consumption for the device's storage state firmware shown in FIG. 8 and based on the fact that the device is designed to last for a full waking day (at least 16 hours, assuming 8 hours of sleep), the device was equipped with a 500-mAh battery, resulting in a battery lifetime of 19 hours. To ensure that the estimation is correct, the device was fully charged and a volunteer was asked to wear the device until the battery drained completely. The volunteer was instructed to not switch off the device but rather take it off and place it on a table at the end of the study. When the battery was fully depleted the battery lifetime was determined by calculating the difference between the first and last timestamps of readings stored on the SD card. In alternative embodiments, a different size of battery may be used.

Values in FIG. 8 can also be used to estimate battery lifetime when multiple states are used. For example, instead of continuously saving or streaming data, a more energy-efficient approach will only save or send the data when there is a high probability of a smoking event (i.e., when a hot pixel (exceeding a temperature threshold) is detected). Included below is a discussion of how to perform such analysis based on the data that was collected to demonstrate how an opportunistic data collection approach can further reduce the power consumption of the device to enable longer battery life or to facilitate real-time processing via Bluetooth low energy (BLE) or another transmission technique.

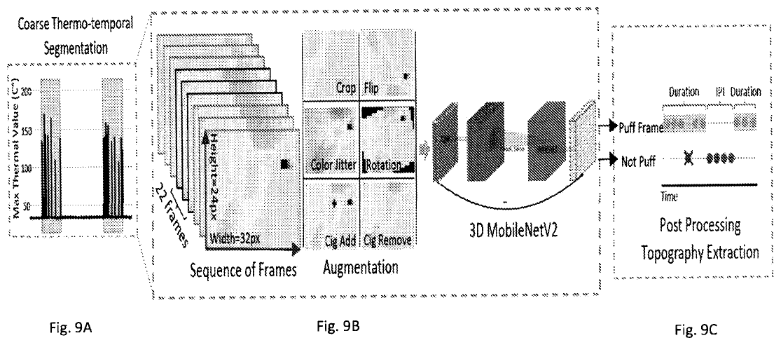

FIG. 9 illustrates the device framework for extracting smoking topography. Specifically, FIG. 9A depicts extraction of possible smoking sessions based on thermal information in accordance with an illustrative embodiment. FIG. 9B depicts a puff-detection model that was run on each frame in the extracted session in accordance with an illustrative embodiment. FIG. 9C depicts the results of postprocessing to extract puffing events and the smoking topography of the session in accordance with an illustrative embodiment. The device first performs coarse thermo-temporal segmentation to automatically discard time segments with low probability of smoking. Within each remaining time segment, the device runs a puff classification model on each frame and then constructs a puff event by post-processing the frame-level puff prediction. Finally, the device extracts the smoking topography based on the constructed puff events.

Passive wearable devices deployed in free-living settings collect massive amounts of data about both relevant (i.e., smoking) and irrelevant activities. Running a machine learning model on each time segment can be inefficient as it unnecessarily increases computational load and energy consumption. Since the device is interested in smoking segments of the data, a coarse thermo-temporal segmentation can be performed to discard irrelevant time segments and keep time segments with a high probability of involving smoking activity (i.e., segments that have at least one pixel with a high temperature value that may belong to the tip of a burning cigarette). To reduce the runtime and energy consumption of the coarse thermo-temporal segmentation step, a heuristic-based algorithm was designed that can efficiently run either on-device on the device MCU or on an offline CPU after extracting the data from the SD card.

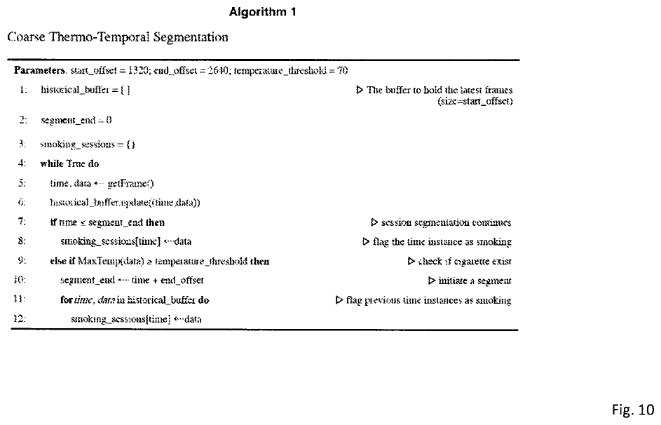

FIG. 10 depicts a heuristic-based algorithm to analyze collected data and generate smoking topography information in accordance with an illustrative embodiment. The algorithm loops over the frames and checks the maximum pixel value of each frame F₁ and creates a candidate smoking session if the maximum value is >70° C. (determined empirically based on the lower bound of the cigarette tips in the dataset). In alternative embodiments, a different threshold temperature may be used, such as 550 C, 60° C., 75° C., 80° C., etc. For each Fᵢ frame that is flagged as containing potential smoking activity, the algorithm also flags previous and future frames within the range of F_{i-start_offset}, F_{i+end_offset} to include likely puff events without cigarette visibility and to obtain a coarse thermo-temporal segment. The offset is a variable in the algorithm that can be adjusted based on the IPI duration. The resulting segments include both smoking and other confounding contexts or activities that can have a high thermal pixel value (e.g., hot drinks and spotlight lighting). In the next operation, device uses a deep learning approach to classify puff frames to further eliminate confounding and non-smoking frames.

Specifically, a deep neural network model was trained to determine whether a participant was performing a cigarette puff in frame Fᵢ. For each frame Fᵢ, frames Fᵢ₋₁₁ to Fᵢ₊₁₁ were stacked to create a 3D input data of size 23×32×24, which was fed into the neural network. A MobileNetV2 architecture was used because it is a light model that can run efficiently on edge devices and enable real-time inference if needed. The 2D convolution layers were replaced with their 3D counterparts to capture temporal information related to the puff gesture. Instead of randomly initializing the weights in the neural network, transfer learning was used to initialize the network with weights obtained from a similar model pretrained on a gesture-recognition dataset.

To overcome the challenge of between- and within-subject variability of smoking gestures, the training set was augmented by using the following transformations (FIG. 9 shows visuals): (1) cigarettes were randomly removed from the frame to force the neural network to learn puffing gestures with and without a visible cigarette. This was accomplished by first locating the cigarette in the frame and then using an in-painting method to remove the cigarette. (2) The inventors also randomly added cigarette confounding blobs in the image to ensure that the network learns the difference between a cigarette in hand and a random hot blob that looks like a cigarette. (3) Since temperature readings are affected by environmental factors such as cold weather, the inventors arbitrarily applied brightness jitter to images, which is a data-augmentation technique. (4) The inventors also applied other common augmentation methods such as random crop, random flip, and random rotation to account for device position variability. To further increase the resilience of the models, data from two participants performing confounding gestures such as drinking water of varying temperature and touching their face (one hour each person) were intentionally collected to augment the training set. In addition, a binary cross entropy loss function was used with Adam optimizer and a learning rate scheduler was selected to run gradient descent until convergence. The model's performance was measured with a leave-one-participant-out cross-validation method.

After detecting the smoking frames, the puff frames were clustered based on temporal proximity (e.g., 12 seconds maximum) to create a puffing event. Clusters with less than 2 positive puffing frames are discarded. After obtaining the puff events, the following smoking topography was calculated: number of puffs, puff duration, and IPI. For the in-lab data only, the puff volume was also determined for ground truth. Puff volume is calculated from thermal data by first normalizing the data using each participant's mean and standard deviation. Then for each puff event, a time series of the maximum value of each frame in the puff event was extracted to create a maximum temperature curve. The change of maximum temperature within a puff is highly correlated with airflow going through the cigarette. To measure volume, the device generates a flow curve (a time series measurement of flow generated using a pressure transducer) for each puff and integrates over the flow curve. In the proposed device, the inventors integrate over the max temperature curve within the puff to estimate volume. To obtain a mapping between the estimation and ground truth, a linear regression model was trained using leave-one-participant-out cross-validation to estimate the puff volume.

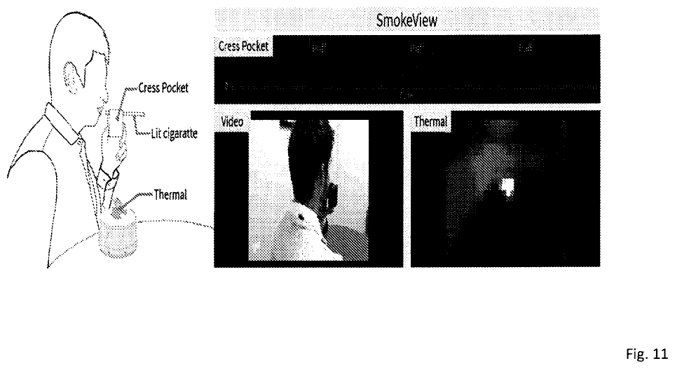

To evaluate the device, in-lab and in-wild experiments were conducted. A controlled in-lab experiment was conducted to compare the performance of the device against a traditional device. The elements of smoking topography considered for the in-lab evaluation were the number of puffs, puff duration, puff volume, and the duration of the inter puff interval. To extract ground truth smoking topography, a traditional device was used. Participants were asked to smoke a cigarette using a traditional device and the proposed device together to provide smoking topography measurements from both devices for each smoking episode. To use the traditional device, participants inserted a lit cigarette into one end of the device and inhaled through the other end using a disposable tip. FIG. 11 depicts the experimental setup used to confirm efficacy of the proposed device in accordance with an illustrative embodiment.

During the pilot study, it was noted that the unnatural position of the cigarette caused by using the traditional device obstructed the proposed device's view of the cigarette. In light of this, the experiment was revised so that the proposed device was not worn but rather placed on the table in front of the participant to compensate for the cigarette offset created by the traditional device. Because the timekeeping mechanisms of the two devices differ, all sessions were videotaped to facilitate synchronization of the proposed device and the traditional device. After teaching participants how to smoke using the traditional device, the participant was left alone in the room and asked to smoke a cigarette. Participants smoked one cigarette of their choice (provided by the study team).

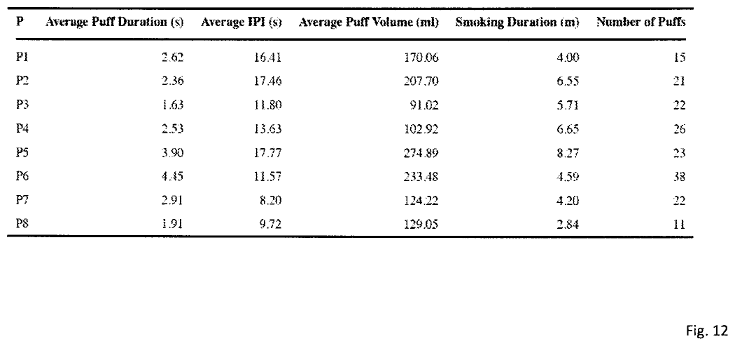

Data was collected from 8 participants (7 male, 1 female). FIG. 12 includes a table with details about the collected smoking topography using the traditional device in accordance with an illustrative embodiment. To synchronize data collected from the proposed device, software (SmokeView) was developed to visualize the data collected during the experiment: video, device thermal data, and the puff time series from the traditional device. The inventors marked the lighting event, the first puff in the video, and the first puff observed in the proposed device to calculate the offset between the video and the device. The inventors also marked the first puff using the traditional device to synchronize data from the traditional device to the video. After syncing the data, the inventors removed the puffs that were not captured by the traditional device, which were puffs used to light the cigarette.

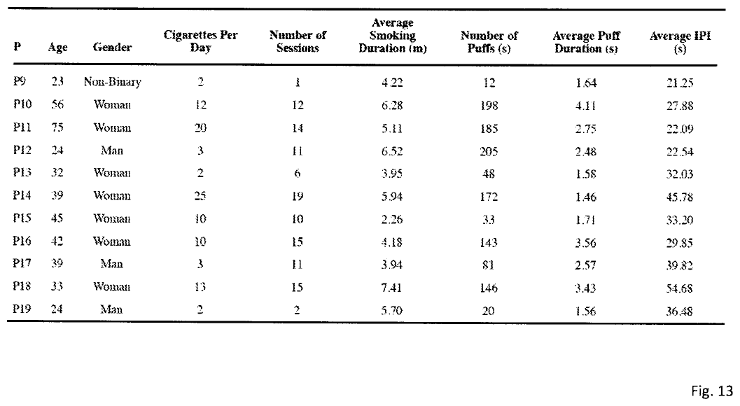

An in-wild experiment was also conducted. The objective of the in-wild experiment was to test the device under realistic everyday conditions. Participants were asked to wear the device in a natural setting for at least 10 hours. Participants were also asked to keep a log of their smoking session, which was used to obtain a fine-grained annotation of the smoking session and its puffs. FIG. 13 includes a table that provides summary statistics of the data collected in the wild in accordance with an illustrative embodiment.

For the in-wild experiment, participants were instructed on how to wear and operate the SmokeMon device. They were asked to wear the device in the laboratory and smoke and drink a beverage of their choice in the laboratory to ensure that they understood the instruction and to answer any further questions they might have. Participants also had a chance to see a sample of the thermal images collected in the laboratory to demonstrate the type of information that was being collected as part of the informed consent process. The participants were asked to wear the device for at least 10 hours in the wild and requested that both smoking and non-smoking events (i.e., eating, drinking, etc.) take place while wearing the device. Participants were also asked to log the start time of their smoking event by noting it in an electronic or paper log. No participant deleted any data, and at the end of the experiment participants were asked to fill out a post-experiment questionnaire.

As noted, at the end of the study, participants engaged in a post-experiment questionnaire. Participants were asked about their general impression of the experience and whether they faced any discomfort while wearing the device or if it interfered with their daily lives. Participants were also asked to report bystander reactions and any discomfort communicated to them by the bystanders. Participants were further asked questions about their thermal data and if they had any concerns about sharing it.

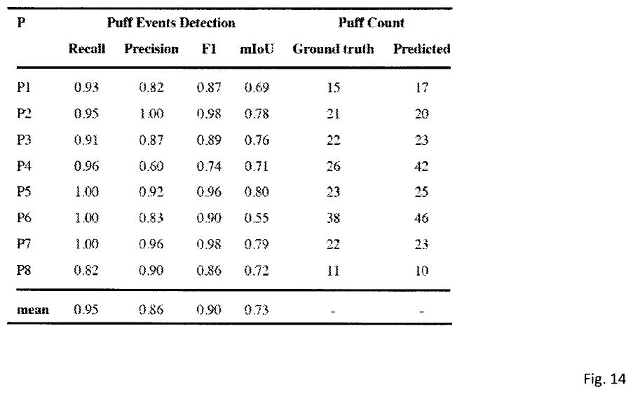

For the in-wild experiment, the start and end of each puff gesture in a smoking event were marked, and the participants' self annotation of their smoking was used to locate the smoking events. The entire dataset was viewed if a participant reported that they forgot to log a smoking event. The inventors then calculated the following topography from the ground truth labels for each smoking event: (1) start and end of smoking event, (2) puffs per cigarette, (3) puff duration, and (4) IPI. Puff volume was not extracted from the in-wild data because there was no ground truth for it. As discussed above, for the in-lab experiment, a traditional device (CReSS Pocket) was used for ground truth. However, the traditional device could not be used as a ground truth device in the wild because the device itself interferes with smoking behavior. A total of 110 hours of data was collected containing 115 smoking sessions obtained from 11 participants (different participants than in the laboratory). FIG. 14 includes a table that shows the number of smoking and puff event statistics for each participant of the in-wild study in accordance with an illustrative embodiment.

The smoking topography extraction approach was evaluated using a leave-one-participant-out method in which the models were tested on one participant and trained with the remaining participants. The model used predicts puffing frames followed by a post-processing method that creates events and is evaluated at an event level. Metrics are reported such as the positive precision, recall, F1 score (positive), and intersection over union (IoU) between ground truth and predicted puff events for each participant individually. Using the true positive puff events, the error in smoking topography measurements is also reported. Only the true positive puffs were used to prevent carryover errors from the detection task, which are reported independently. To analyze the agreement between the proposed device measurement and ground truth, Bland-Altman plots are used, which is a method often used to compare gold standards and new instruments in medical and clinical research.

The table of FIG. 14 shows the result of puff event detection from the in-lab experiment using the proposed device. The average positive F1 score for puff detection was high (0.9). The per-person F1 score was also high (above 0.85) for most of the participants. The inventors inspected low puff detection results to understand the source of the error and the limits of the current model. For P4, recall was very low compared with other participants. Upon inspecting P4's false positives, it appeared that P4 kept the cigarette near the face outside of puff events, and the model predicted this action as a puff. Augmenting the training dataset with such cases can further improve the model prediction. Overall, the device achieved 0.95 recall, 0.86 precision, and 0.90 F1 score in the in-lab experiment, with more than 50% mean IoU.

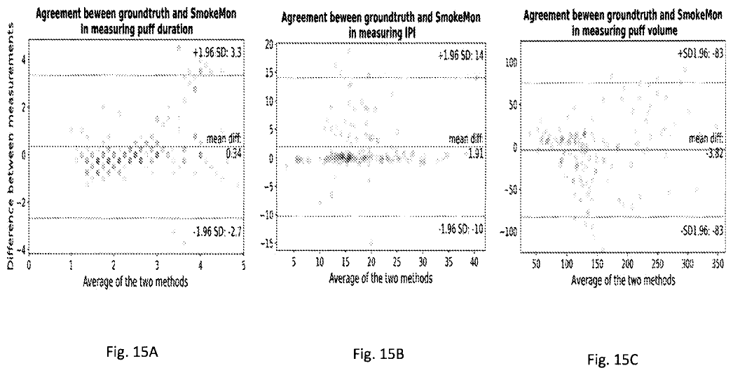

FIG. 15 shows the Bland-Altman plots that compare smoking topography obtained from ground truth and those obtained from the proposed device. FIG. 15A shows agreement between ground truth and the proposed device in measuring puff duration in accordance with an illustrative embodiment. FIG. 15B shows agreement between ground truth and the proposed device in measuring duration of time between the end of a puff and the start of a subsequent puff (IPI) in accordance with an illustrative embodiment. FIG. 15C shows agreement between ground truth and the proposed device in measuring puff volume in accordance with an illustrative embodiment. The mean difference was minimal in all plots (0.34 sec for puff duration, 1.91 seconds for IPI, and −3.82 for puff volume). For puff duration and IPI, most points were close to the zero line (the closer the points to the zero-line, the greater the agreement between ground truth and the device measurements). The puff volume plot shows greater variability, particularly as the volume average increases, indicating a deviceatic bias in the measurement or the calibration process of the ground truth device. However, most points were between ±1.96 standard deviations (SDs), which was considered acceptable. Among the outlier points (i.e., located outside of the ±1.96 SD limit) for each plot, all puffs that were above+1.96 SD belonged to P6 with long duration puffs (mean =6.1 sec). These long duration puffs occurred when the participant kept the cigarette in their mouth while taking multiple puffs.

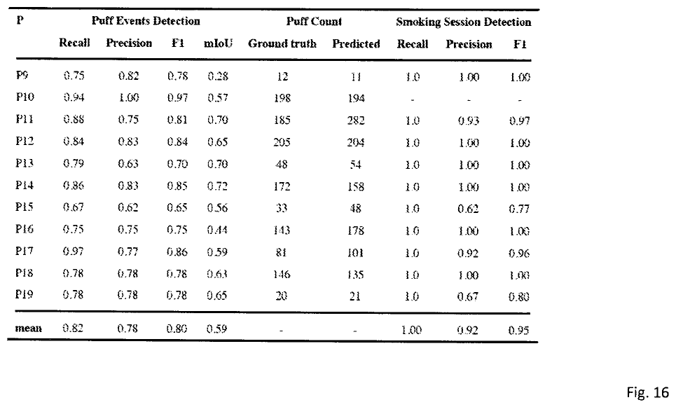

FIG. 16 includes a table that highlights the results of puff event and smoking session detection from the in-wild experiment using the proposed device in accordance with an illustrative embodiment. Specifically, FIG. 16 shows in-wild average puff prediction per participant, puff count, and smoking session detection. It is noted that P10 smoking session detection analysis was removed because the ratio of smoking events to nonsmoking events was not similar to other participants because the participant did not follow the study protocol and turned the device on during smoking sessions only. All other smoking sessions were extracted (Recall 1, in FIG. 16). The model average F1 score was 0.8 across all participants and above 0.75 for most participants. The inventors investigated P15's false-positive and false-negative cases because the recall and precision were low. It appeared that the position of the device for P15 was quite different than other participants (i.e., head not fully visible in the FoV), which accounted for low recall. Also, P15 kept the cigarette near their mouth and visible in the FoV between puffs, which confused the model with false positives. Overall, the device achieved 0.82 recall, 0.78 precision, and 0.8 F1 scores for the in-wild experiment with more than %50 mean IoU.

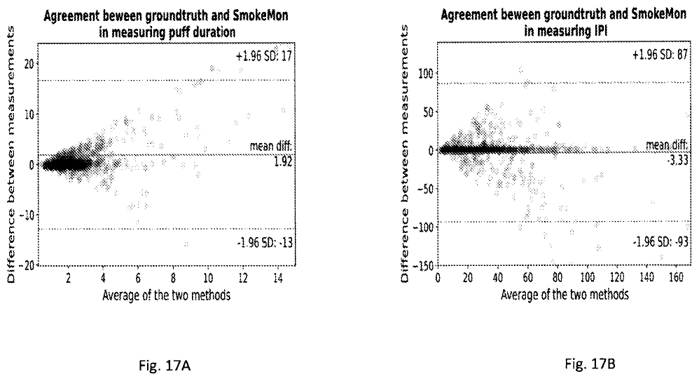

FIG. 17 shows the in-wild Bland-Altman plots that compare smoking topography obtained from ground truth with the ones obtained from the proposed device. FIG. 17A shows agreement between ground truth and the proposed device for in-wild puff duration in accordance with an illustrative embodiment. FIG. 17B shows agreement between ground truth and the proposed device for in-wild IPI in accordance with an illustrative embodiment. The mean difference was minimal in all plots (1.92 sec for puff duration and −3.33 sec for IPI). In both plots, most points clustered around the zero-line, showing high similarity between the ground truth measure and the device. Puff duration and IPI error increase and fluctuate more frequently as the average increases. However, similar to the in-lab results, most points were within the ±1.96 SDs considered acceptable. Among the outlier points (i.e., located outside±1.96 SD limit) for each plot, all puffs that were above+1.96 SD belonged to a few sessions from P10 with long duration puffs (mean =5.4 sec).

As discussed above, the inventors profiled each state supported by the device firmware, including sensing only, storage, and communication/transmission (e.g., BLE). For data collection, the device was set to operate in the storage state to increase the experiment's reliability and validity. Using the storage state continuously still produced an energy-efficient device (19 hours of battery life). Energy consumption using both storage and BLE states under an opportunistic rather than continuous data collection method is discussed below. As discussed, the coarse thermo-temporal segmentation was used to filter out irrelevant and highly unlikely smoking frames. The same algorithm was used to switch the state of the device firmware from sensing only to storage or transmission. If the frame was unlikely to be smoking, the inventors did not activate the storage or the BLE state and just used the sensing-only state. The storage or the transmission state only were activated when the algorithm detected a smoking segment. The collected in-wild data was used to simulate a realistic scenario of state change triggered by the algorithm. Then the state power consumption that was estimated for each state was used.

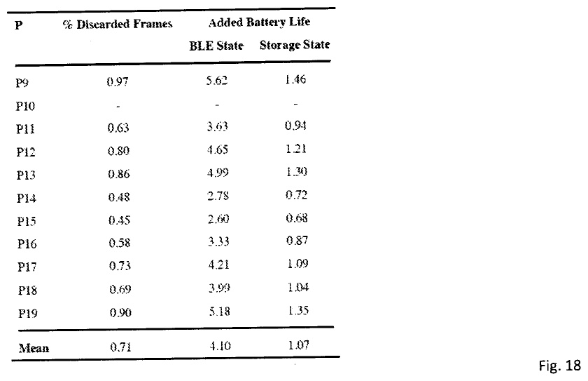

FIG. 18 is a table that shows the percentage of discarded frames from each participant in accordance with an illustrative embodiment. On average, a reduction of 71% frames was achieved. Using the number of discarded frames, the inventors calculated the added battery life (in hours) to the device when transmission and storage states were activated opportunistically using the algorithm. On average, when the algorithm was used to activate the transmission state opportunistically, the battery life increased by 28% (4.1 hours), while streaming the data using BLE. Similarly, the battery life improved by 6% (1.07 hours) on average when the storage state was activated using the algorithm. For instance, the algorithm identified 3% of the collected data as smoking related for P9, which meant that the device only streamed (transmission state) or stored (storage state) this portion of the data. As a result, the device was in the sensing-only state for most of the time (97%), which was the most power-efficient state.

When asked their thoughts about wearing the proposed device to collect information about their activity, most participants expressed positive comments that affirm the unobtrusive design of the device. Participants report that it was “comfortable,” “easy”, and “not a problem” to wear the device. Also, participants report that they “forgot” about the device, “didn't notice it,” and that it “did not get in the way.” Two participants reported that the device was “bulky” and the size of the device made one of those participants self-conscious and embarrassed to wear it in public. One way to improve wearability of the device is to attach it to clothing directly (e.g., using a pin or adhesive) rather than using magnets.

The participants were also asked if there were any situations in which wearing the device made them feel uncomfortable. None of the participants mentioned any discomforting situation. Participants reported taking off the device while sleeping and showering, which was expected as they were told to take it off during these times. Participants were also asked if the device changed how they went about their daily activities in general and specifically while smoking. Eight participants mentioned that the device did not interfere with their daily activities. The remaining three mentioned that they were more conscious about their everyday activities that can interfere with the device (e.g., napping). Most participants reported that the device did not interfere with their smoking behavior.

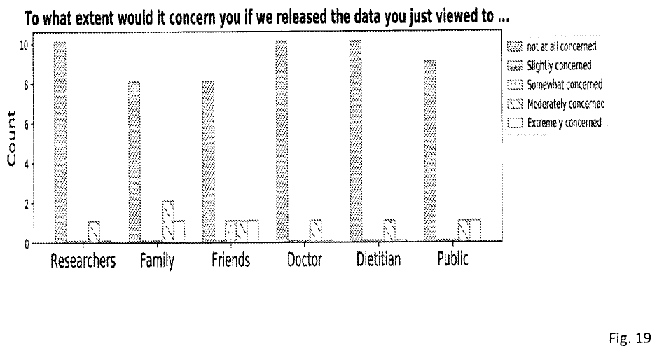

Participants were asked if the device made anyone around them uncomfortable or if anyone asked them to turn off the device. Two participants mentioned that people they knew were curious about the device and what it records, which prompted participants to explain that the device captures only thermal images. None of the bystanders expressed any concerns. After viewing their data, the inventors asked participants how concerned they would be if their data were released to the following groups: other researchers, family, friends, doctors, dietitians, and the general public. FIG. 19 depicts participant survey results regarding sharing data collected by the proposed device in accordance with an illustrative embodiment. FIG. 19 shows that most participants were “not at all concerned” with sharing their data with researchers, doctors, dietitians, or the general public. Two participants reported more concerns when their data were shared with friends or family but not the general public, which may suggest sensitivity of sharing smoking behavior data with people they are familiar with as opposed to just sharing thermal images about them. Overall, these results show the promise of low-resolution thermal images providing sufficient, rich data that people are willing to share with the public for the greater good.

In summary, the test results indicated that the device was able to detect smoking sessions with high recall and precision. The device is able to verify if the wearer is smoking or not, both automatically using an algorithm or by manually inspecting the thermal images. In an illustrative embodiment, the device detects smoking puffs using a single high-information-sensing modality that is comfortable to wear.

Puff behaviors can vary between and within subjects, making the puff detection task challenging. For example, as seen in the dataset, people may alternate which hand they use for smoking, hold the cigarette in their mouth for a long time, and engage in other non-smoking hand gestures while holding the cigarette. To overcome the puff detection challenge, the device uses a thermal sensor to capture challenging smoking cases without requiring additional sensor instrumentation, such as an RGB camera. Additionally, data collected by the device did not cause privacy concerns or discomfort to the wearer or bystanders.

The SmokeMon is the first device that attempts to utilize thermal sensors to extract smoking topography unobtrusively without requiring contact with the cigarette or interfering with the smoking habits. It was shown that, on average, the device performs as well as current smoking topography devices and ground truth. Additionally, the smoking topography results can be further improved by adding one or more sensors to measure breathing patterns of the user, especially when the cigarette is occluded by the user's hand or when the user is holding the cigarette in their mouth without the hand. Chest sensors that can measure respiration rate and volume are in development. In the future, such sensors can be placed in a magnetic pad of the device, which can have direct contact with the user's skin.

Although device placement and sensor angle for each participant and magnets were added for extra stability, there were instances of collected data in which the sensor position was not ideal (e.g., device tilting). Although data augmentation methods can account for such movements, such techniques cannot handle an extreme shift in position of the device (i.e., when the device was too close to the head, resulting in an image that did not capture anything but the head). To account for this scenario, the device can include a trigger to alert the participants when the sensor is positioned incorrectly. The trigger can be a vibration, an audio alarm, a message sent to a user device (e.g., smartphone) from the smoke monitoring device, etc.

Another approach to account for sensor placement is to increase the FoV of the camera. For example, in one embodiment, multiple thermal cameras can be used to increase the FoV. In the case of SmokeMon, adding a second thermal camera above the first camera would double the vertical FoV. Adding a second camera would reduce also battery life if both cameras were always on. Therefore, to reduce power consumption, the firmware is designed to put the second camera to sleep and only trigger it to wake up during a possible smoking session (e.g., when the first camera observes very high-temperature pixels). In an alternative embodiment, both thermal cameras can be active at all times. In another alternative embodiment, thermal sensor(s) can be placed on other areas than the user's chest, such as the head (e.g., glasses, hat). For example, one may be able to address challenges such as occlusion by using a downward view. Another possible position includes the shoulders, where the cigarette's tip may be more visible across varying environments and body postures.

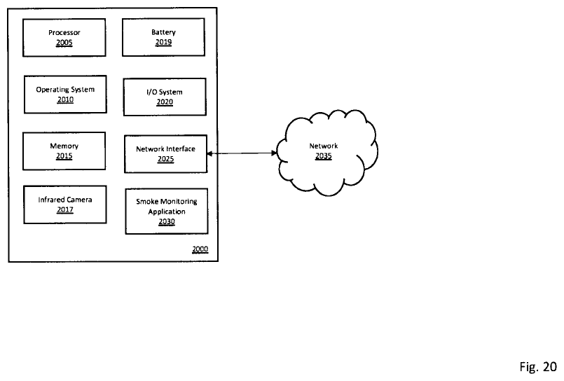

In an illustrative embodiment, any of the operations or calculations described herein can be performed by a computing device that includes a processor, a memory, a user interface, a transceiver (receiver and/or transmitter), etc. The operations can be stored as computer-readable instructions in the memory. Upon execution by the processor of the computer-readable instructions, the computing device performs the operations, calculations, etc. described herein. As an example, FIG. 20 depicts a computing device 2000 for performing smoker monitoring and analysis in accordance with an illustrative embodiment. In an illustrative embodiment, the computing device 2000 can be incorporated into a device that includes all of the components described herein (e.g., the case, magnetic attachment, lens cover, etc.). Alternatively, one or more portions of the computing device 500 can be separate from the remaining components of the device, but in communication therewith through a network 2035 and/or through a direct wired connection.

The computing device 2000 includes a processor 2005, an operating device 2010, a memory 2015, an infrared camera 2017, a battery 2019, an input/output (I/O) device 2020, a network interface 2025, and a smoke monitoring application 2030. In alternative embodiments, the computing device 2000 may include fewer, additional, and/or different components. The components of the computing device 2000 communicate with one another via one or more buses or any other interconnect device.

The processor 2005 of the computing device 2000 can be in electrical communication with and used to control any of the device components described herein, such as the thermal sensor, the I/O device, the network interface, etc. The processor 2005 can be any type of computer processor known in the art, and can include a plurality of processors and/or a plurality of processing cores. The processor 2005 can include a controller, a microcontroller, an audio processor, a graphics processing unit, a hardware accelerator, a digital signal processor, etc. Additionally, the processor 2005 may be implemented as a complex instruction set computer processor, a reduced instruction set computer processor, an x86 instruction set computer processor, etc. The processor 2005 is used to run the operating device 2010, which can be a custom operating device specific to the requirements of the proposed device.

The operating device 2010 is stored in the memory 2015, which is also used to store programs, device data, user information, algorithms, network and communications data, peripheral component data, and other operating instructions. The memory 2015 can be one or more memory devices that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc. The infrared camera 2017 can be any type of thermal sensor. In some embodiments, a plurality of infrared cameras 2017 may be used. The battery 2019 is used to power components of the computing device 2000. Any battery of appropriate size and capacity may be used.

The I/O device 2020, or user interface, is the framework which enables users (and peripheral devices) to interact with the computing device 2000. The I/O device 2020 can include one or more keys or a keyboard, one or more buttons, one or more displays, a speaker, a microphone, etc. that allow the user to interact with and control the computing device 2000. The I/O device 2020 can be used to issue alerts to the user in one embodiment. The I/O device 2020 also includes circuitry and a bus structure to interface with peripheral computing components such as the battery 2019 or power sources, the infrared camera 2017 or other sensors, etc.

The network interface 2025 includes transceiver circuitry that allows the computing device 2000 to transmit and receive data to/from other devices such as user device(s), remote computing devices, servers, websites, etc. The network interface 2025 enables communication through the network 2035, which can be one or more communication networks. The network 2035 can include a cable network, a fiber network, a cellular network, a wi-fi network, a landline telephone network, a microwave network, a satellite network, etc. The network interface 2025 also includes circuitry to allow device-to-device communication such as near field communication (NFC), Bluetooth® communication, etc.

The smoke monitoring application 2030 can include software and algorithms (e.g., in the form of computer-readable instructions) which, upon activation or execution by the processor 2005, performs any of the various operations described herein such as controlling the infrared camera 2017, receiving sensed data, performing analyses of sensed data, generating control signals, generating user alerts, processing test result data, transmitting test result data for remote processing, etc. In one embodiment, the smoke monitoring application 2030 can generate a summary report that details smoking topography for a user. This summary report can be printed and/or provided digitally to the user such that he/she can monitor and track smoking behavior with a goal of reducing smoking. The smoke monitoring application 2030 can utilize the processor 2005 and/or the memory 2015 as discussed above.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A smoke monitoring device comprising:
an enclosure, wherein the enclosure includes a mount that attaches the enclosure to a user;
a thermal sensor positioned within the enclosure; and
a processor operatively coupled to the thermal sensor and configured to:
receive data from the thermal sensor; and
determine smoking topography information based on the received data.

2. The device of claim 1, wherein the received data comprises temperature readings obtained by the thermal sensor.

3. The device of claim 2, wherein the processor determines whether the temperature readings correspond to a smoking event.

4. The device of claim 3, wherein the processor determines whether the temperature readings correspond to the smoking event based on a position of the detected temperature readings relative to a hand or a mouth of the user.

5. The device of claim 2, wherein the received data only includes temperature readings that exceed a temperature threshold that is based on a smoking event.

6. The device of claim 1, wherein the smoking topography information includes a duration of a puff of a cigarette by the user.

7. The device of claim 1, wherein the smoking topography information includes a volume of a puff of a cigarette by the user.

8. The device of claim 1, wherein the smoking topography information includes a duration of time between an end of a puff and a start of a subsequent puff.

9. The device of claim 1, further comprising a transceiver operatively coupled to the processor, wherein the transceiver sends an alert to the user based on the smoking topography information.

10. The device of claim 1, further comprising a transceiver operatively coupled to the processor, wherein the transceiver sends an alert to the user if the thermal sensor is out of position.

11. The device of claim 1, wherein the mount includes a pair of magnets that attach the enclosure to clothing of the user.

12. The device of claim 1, wherein the mount comprises a pin or an adhesive.

13. The device of claim 1, wherein the received data comprises an indication of when a cigarette is lit by the user.

14. A method of monitoring smoking, the method comprising:
mounting an enclosure to a user, wherein the enclosure includes a thermal sensor;
collecting, by the thermal sensor, temperature readings associated with the user; and
determining, by a processor operatively coupled to the thermal sensor, smoking topography information based on the temperature readings.

15. The method of claim 14, further comprising determining, by the processor, whether the temperature readings correspond to a smoking event based on a position of the temperature readings relative to a hand or a mouth of the user.

16. The method of claim 14, wherein the collected temperature readings exceed a temperature threshold that is based on a smoking event.

17. The method of claim 1, wherein the smoking topography information includes a duration of a puff of a cigarette by the user and a volume of a puff of a cigarette by the user.

18. The method of claim 1, wherein the smoking topography information includes a duration of time between an end of a puff and a start of a subsequent puff.

19. The method of claim 1, further comprising sending, by a transceiver operatively coupled to the processor, an alert to the user based on the smoking topography information.

20. The method of claim 1, further comprising sending, by a transceiver operatively coupled to the processor, an alert to the user if the thermal sensor is out of position.
